(19) United States
(12) Patent Application Publication
(10) Pub. No.: US 2026/0226575 A1
(43) Pub. Date: Aug. 6, 2026

(54) THIN GRAIN-ORIENTED ELECTRICAL STEEL SHEET AND MANUFACTURING METHOD THEREFOR

(71) Applicant: POSCO CO., LTD, Pohang-si, Gyeongsangbuk-do (KR)

(72) Inventors: Kyung-Jun Ko, Pohang-si, Gyeongsangbuk-do (KR); ll-Nam Yang, Pohang-si, Gyeongsangbuk-do (KR); Jae-Hwa Song, Pohang-si, Gyeongsangbuk-do (KR)

(73) Assignee: POSCO CO., LTD, Pohang-si, Gyeongsangbuk-do (KR)

(21) Appl. No.: 19/136,841

(22) PCT Filed: Nov. 21, 2023
(86) PCT No.: PCT/KR2023/018811

§ 371 Date: Jun. 6, 2025

(30) Foreign Application Priority Data
Dec. 21, 2022 (KR) 10-2022-0181154

(51) Int. Cl. C21D 9/46; C21D 6/00; C21D 8/1216; C21D 8/1244; C21D 8/1277; C22C 38/00; C22C 38/02; C22C 38/04; C22C 38/06; H01F 1/147

(52) U.S. Cl. CPC C21D 9/46; C21D 6/005; C21D 6/008; C21D 8/1222; C21D 8/1233; C21D 8/1255; C21D 8/1261; C21D 8/1272; C21D 8/1283; C22C 38/001; C22C 38/002; C22C 38/008; C22C 38/02; C22C 38/04; C22C 38/06; H01F 1/14775; C21D 2201/05; C22C 2202/02

(57) ABSTRACT

A thin grain-oriented electrical steel sheet and a manufacturing method therefor are provided. The grain-oriented electrical steel sheet manufacturing method of the present invention comprises the steps of: hot rolling a slab, thereby manufacturing a hot rolled sheet; annealing the hot rolled sheet; cold rolling the annealed hot-rolled sheet, thereby manufacturing a cold rolled sheet; primarily recrystallization-annealing the cold rolled sheet by decarburizing and nitriding same; and secondarily recrystallization-annealing the cold rolled sheet which has been primarily recrystallization-annealed.

### TECHNICAL FIELD

The present disclosure relates to manufacturing of a thin grain-oriented electrical steel sheet, and particularly, to a grain-oriented electrical steel sheet which reduces a magnetic deviation of a thin product by controlling residual Al content in a slab depending and hot-rolled sheet annealing conditions on a hot rolled thickness, and controlling a nitriding amount of a steel sheet depending on a cold rolled thickness, and a manufacturing method therefor.

### BACKGROUND ART

A grain-oriented electrical steel sheet is used as an iron core material of stationary devices such as transformers, motors, generators, and other electronic devices. Since a grain-oriented electrical steel sheet final product has an magnetic properties in a rolling extremely excellent direction by orientation of crystal grains having a texture oriented in the (110)[001] direction, it may be used as an iron core material of transformers, motors, generators, other electronic devices, and the like, and is required to have low iron loss for decreasing energy loss and a high magnetic flux density for miniaturization of power generation equipment.

The iron loss of the grain-oriented electrical steel sheet is divided into hysteresis loss and eddy current loss, and of the two, in order to decrease eddy current loss, efforts such as increasing inherent specific resistance and decreasing a product sheet thickness are required. There is a difficulty of rolling a grain-oriented electrical steel sheet which is a hardly rolled product in a direction of decreasing a product sheet thickness into an extremely thin product, however, the biggest difficulty and problem to overcome in manufacturing an extremely thin product having low iron loss properties is maintaining sharpness of Goss orientation which is a secondary recrystallization structure of the grain-oriented electrical steel sheet to be significantly strong.

Upon review of problems in rolling for manufacturing an extremely thin product, it is known that an optimal reduction rate during manufacture of the grain-oriented electrical steel sheet via a low-temperature heating method and one strong cold rolling process is usually about 90%. In order to secure a cold rolling rate of 90%, hot rolling to a hot rolled sheet thickness of 1.5 to 2.3 mm or less is needed. As the hot rolled thickness becomes thinner, a higher reduction rate is needed, and productivity drops for the reason of hot rolling temperature maintenance, shapes of an edge part of a hot rolled sheet such as edge scab, a coil top, and a tail part, and the like. In addition, as the length of a hot rolled coil is increased, a difference in rolling time between the coil top part and a tail part, and a difference in hot rolling temperatures inevitably occur, so that it becomes more unfavorable to form uniform fine precipitates in a coil length direction. In addition, when a slab is moved in a reheating furnace when heating the slab for hot rolling, a difference in solid solution precipitates (fine precipitates) inevitably occurs in a length direction of a hot rolled sheet due to a temperature deviation caused by a temperature of a skid contact part lower than a non-contact part, and the difference causes a problem which leads to a deviation in magnetic properties of a final product.

A more important problem is that as a product thickness becomes thinner, during a secondary recrystallization annealing process, in particular, precipitate loss from the surface in a section where secondary recrystallization of the Goss orientation occurs is accelerated, so that it is difficult to maintain a strong Goss orientation integration. This is a problem directly related to magnetic properties of a product and makes difficult to secure very low iron loss properties by manufacturing an extremely thin product. As precipitate loss of crystal grains which is not in a Goss orientation is accelerated with the thinning thickness, the crystal grains grow and form coarse crystal grains penetrating through the thickness direction, and at this time, the coarse crystal grains do not disappear easily even with annealing at a high temperature for a long time and cause iron loss unevenness.

As a method for overcoming precipitate loss, a method for preventing precipitate loss by increasing a N₂ gas fraction in a secondary recrystallization annealing process has been suggested, but the method causes surface defects such as a nitrogen outlet on the surface of a product sheet.

An economical manufacturing using a method simultaneous decarburizing and nitriding method has also been suggested. In manufacturing a decarburized sheet by a simultaneous decarburizing and nitriding method, it was specified that there is a difference between a crystal grain diameter on the surface and a crystal grain diameter in the center layer, and it has been suggested that this needs to be controlled to a specific range.

A technology of significantly improving magnetism by including segregated elements such as Sb, P, and Sn has also been suggested. When an extremely thin product is manufactured by further adding segregated elements, the segregated elements are used as an auxiliary inhibitor for compensating for precipitate loss during manufacture of an extremely thin product, but when added in excess, ultra-thin rolling is difficult, and an oxidation layer becomes uneven and thinner to deteriorate the characteristics of a base coating to further cause precipitate loss, and thus, magnetism is not stably secured.

A method for adjusting oxidation capacity and nitriding treatment of a front end part in a primary recrystallization annealing process when manufacturing an extremely thin product has been suggested. However, in manufacturing an extremely thin product, the effect of the precipitate loss becomes very sensitive.

In addition, a method of adding Cr to a slab and adjusting a nitriding gas addition amount to a front end part and a rear end part in a primary recrystallization annealing process has been suggested. However, the method uniformly maintains a nitrogen amount in a steel sheet thickness direction, but AlN precipitates are unevenly distributed so that there is still a deviation in magnetic properties. In addition, by adding Cr, an oxidation layer depth deepens and base coating thickness increases, and a problem in manufacturing an extremely thin product in which the proportion of a coating layer increases in the product also arises.

### RELATED ART DOCUMENT

### Patent Document

(Patent Document 1) Korean Patent Laid-Open Publication No. 2001-0060418

### SUMMARY OF INVENTION

### Technical Problem

An aspect of the present disclosure is to provide a grain-oriented electrical steel sheet which may reduce a magnetic deviation of a thin product by controlling a residual Al amount in a slab and hot rolled steel sheet annealing conditions depending on a hot rolled thickness, and controlling a nitriding amount of a steel sheet depending on a cold rolled thickness, and a manufacturing method therefor.

An object of the present disclosure is not limited to the above description. Any person with ordinary skill in the art to which the present disclosure pertains will have no difficulty in understanding further objects of the present disclosure from the general details the specification of the present disclosure.

### Solution to Problem

According to an aspect of the present disclosure,
a manufacturing method for a thin grain-oriented electrical steel sheet includes: hot rolling a slab including, by weight: 2.5 to 4.0% of Si, 0.03 to 0.09% of C, 0.0150 to 0.0400% of Al, 0.04 to 0.15% of Mn, 0.010% of less (excluding 0%) of S, 0.0020 to 0.0120% of N, 0.010 to 0.050% of P, and 0.03 to 0.12% of the sum of one or more of Sn and Sb with a remainder of Fe and unavoidable impurities to manufacture a hot rolled sheet; annealing the hot rolled sheet; cold rolling the annealed hot-rolled sheet to manufacture a cold rolled sheet; performing primary recrystallization annealing by decarburizing and nitriding the cold rolled sheet; and performing secondary recrystallization annealing of the cold rolled sheet after completing the primary recrystallization annealing,
wherein contents of Al and N in the slab satisfy the following Relations 1 and 2,
when a temperature difference between a heating temperature T1 and a soaking annealing temperature T2 in the hot-rolled sheet annealing is ΔT, ΔT≥200° C. is satisfied, and when cooling from T1 to T2, a cooling rate is controlled to 30° C./sec or less, and
a nitrogen amount ΔN increasing in the cold rolled sheet by the nitriding in the primary recrystallization annealing satisfies the following Relation 3:

$$0.039 - 0.1 Ht \leq [ Al ] - 27 / 14 \times [ N ] \leq 0.047 - 0.01 Ht \qquad [ Relation 1 ]$$

$$15.5 - 5 Ht \leq [ Al ] / [ N ] \qquad [ Relation 2 ]$$

wherein [Al] and [N] denote contents (wt %) of Al and N in the slab, respectively, and Ht denotes a thickness (mm) of a final hot rolled sheet,

$$[ Al ] - 27 / 14 \times [ N ] + ( 0.23 - Ct ) * 0.125 \leq ( 27 / 14 ) Δ N \leq 0.03 \qquad [ Relation 3 ]$$

wherein [Al] and [N] denote contents (wt %) of Al and N in the slab, respectively, and Ct denotes a thickness of a final cold rolled sheet.

The slab may further include 0.02 to 0.15% of Cr.

The slab may further include 0.01 to 0.2% of Cu and 0.01 to 0.05% of Bi.

The slab may include the sum of one or more of 0.002 to 0.01% of Ti and 0.002 to 0.01% of V in a range of 0.002 to 0.01%.

The primary recrystallization annealing process may be performed at a temperature of 800 to 900° C. for 60 to 180 seconds.

According to another aspect of the present disclosure,
a thin grain-oriented electrical steel sheet includes: by weight: 2.5 to 4.0% of Si, 0.03 to 0.09% of C, 0.0150 to 0.0400% of Al, 0.04 to 0.15% of Mn, 0.010% of less (excluding 0%) of S, 0.0020 to 0.0120% of N, 0.010 to 0.050% of P, and 0.03 to 0.12% of the sum of one or more of Sn and Sb with a remainder of Fe and unavoidable impurities, wherein a nitrogen amount ΔN increasing in the steel sheet by nitriding satisfies the following Relation 3:

$$[ Al ] - 27 / 14 \times [ N ] + ( 0.23 - Ct ) * 0.125 \leq ( 27 / 14 ) Δ N \leq 0.03 \qquad [ Relation 3 ]$$

wherein [Al] and [N] denote contents (wt %) of Al and N in the steel sheet, respectively, and Ct denotes a steel sheet thickness.

### Advantageous Effects of Invention

The grain-oriented electrical steel sheet according to an exemplary embodiment of the present disclosure may reduce a magnetic deviation and improve magnetic properties of a thin grain-oriented electrical steel sheet product, specifically by controlling residual Al content in a slab and hot-rolled sheet annealing conditions depending on a hot rolled thickness, and furthermore, by controlling a nitriding amount of a steel sheet depending on a cold rolled thickness.

### BEST MODE FOR INVENTION

Hereinafter, exemplary embodiments of the present disclosure will be described in detail so as to be easily practiced by a person skilled in the art to which the present disclosure pertains. However, the present disclosure may be implemented in various different forms and is not limited to the embodiments provided in the present description.

A manufacturing method for a grain-oriented electrical steel sheet according to an exemplary embodiment of the present disclosure includes: heating a steel slab and then hot rolling the slab to manufacture a hot rolled sheet; annealing the hot rolled sheet; cold rolling the annealed hot-rolled sheet to manufacture a cold rolled sheet; performing primary recrystallization annealing by decarburizing and nitriding the cold rolled sheet; and performing secondary recrystallization annealing of the cold rolled sheet after completing the primary recrystallization annealing.

Hereinafter, the manufacturing method for an electrical steel sheet of the present disclosure will be described in detail in order of process.

### [Manufacture of Hot Rolled Sheet]

First, in the present disclosure, a slab including, by weight: 2.5 to 4.0% of Si, 0.03 to 0.09% of C, 0.0150 to 0.0400% of Al, 0.04 to 0.15% of Mn, 0.010% of less (excluding 0%) of S, 0.0020 to 0.0120% of N, 0.010 to 0.050% of P, and 0.03 to 0.12% of the sum of one or more of Sn and Sb with a remainder of Fe and unavoidable impurities is hot rolled to manufacture a hot rolled sheet.

Herein, in the present disclosure, before manufacturing the hot rolled sheet, a step of heating a steel slab may be included. Precipitates may be partially solubilized by the heating step, and furthermore, coarse growth of a columnar structure of a slab may be prevented to prevent crack occurrence in the width direction of a sheet in a subsequent hot rolling process. However, when a slab heating temperature is too high, a heating furnace is repaired due to melting on the surface of a slab and the life of the heating furnace may be shortened, and thus, in the present disclosure, it is preferred that the heating temperature is 1130 to 1200° C. When the slab heating temperature is too low, the heating effect described above may not be expected. Meanwhile, in the present disclosure, it is possible to carrying out a hot rolling of a continuously cast slab as it is without heating the slab.

Hereinafter, the alloy components of the slab of the present disclosure and the reasons for limiting the contents will be described, and herein, the content of each component element is based on the weight.

### Si: 2.5 to 4.0%

Silicon (Si) serves to lower iron core loss, that is, iron loss by increasing the specific resistance of a grain-oriented electrical steel sheet. When a Si content is too low, specific resistance may be decreased to deteriorate iron loss. When the Si content is too high, brittleness of a steel is increased and toughness of a steel is decreased to increase a sheet fracture incidence in a rolling process, weldability is deteriorated to cause a load on a cold rolling operation, the temperature is below the sheet temperature required for pass aging during cold rolling, and secondary recrystallization formation may become unstable. Therefore, in the present disclosure, it is preferred to control the Si content to a range of 2.5 to 4.0%, more preferably 3.0 to 3.5%.

### C: 0.03 to 0.09%

Carbon (C) is an element which induces formation of an austenite phase, and as a C content increases, ferrite-austenite phase transformation in a hot rolling process is activated, a long extended hot rolling band structure which is formed in a hot rolling process is increased, and ferrite particle growth during an annealing process of hot rolled steel sheet is inhibited. In addition, as the C content increases, a stretched hot rolled band structure having higher strength than a ferrite structure is increased and initial particles of a hot-rolled steel sheet annealed structure which is a cold rolling start structure are refined, so that texture is improved after cold rolling, in particular, a Goss fraction is increased. This is considered due to the fact that a pass aging effect during cold rolling is increased by residual C present in a steel sheet after the hot-rolled steel sheet annealing and the Goss fraction in primary recrystallized grains is increased. Thereafter, a higher C content is favorable, but during subsequent decarburizing and nitriding annealing, a decarburizing annealing time becomes longer, productivity is damaged, and when decarburizing at the initial stage of heating is insufficient, primary recrystallized grains become non-uniform to make secondary recrystallization unstable. In addition, since magnetic properties may be deteriorated by a self-aging phenomenon, it is preferred that the C content in the present disclosure is limited to a range of 0.03 to 0.09 wt %. More preferably, C is included in a range of 0.05 to 0.07 wt %. As described above, carbon is removed by decarburizing during primary recrystallization annealing, and a finally manufactured grain-oriented electrical steel sheet may include 0.005% or less of C.

### Al: 0.0150 to 0.0400%

Aluminum (Al) is bonded to N and precipitated as AlN, but forms a fine precipitate (Al, Si, Mn) N and a nitride in the form of AlN during the annealing performing decarburizing and nitriding and serves to strongly inhibit crystal grain growth. As such, a certain amount or more of solubilized Al is needed. When the content is too low, the number and the volume fraction of formed precipitate are small, so that a crystal grain growth inhibition effect may be insufficient. When Al is included too much, the precipitate coarsely grows to reduce the crystal grain growth inhibition effect. Therefore, in the present disclosure, it is preferred to control Al to a range of 0.0150 to 0.0400%, more preferably 0.0200 to 0.0380%.

### Mn: 0.04 to 0.15%

Manganese (Mn) has an effect of decreasing iron loss by increasing specific resistance identically to Si, and is an important element for causing secondary recrystallization by reacting with nitrogen introduced by a nitriding treatment together with Si to form a precipitate of (Al, Si, Mn)N to inhibit primary recrystallized grain growth. In addition, Mn forms a surfide precipitate with Cu to improve primary recrystallized grain uniformity, and partially serves as an auxiliary inhibitor in forming secondary recrystallization. However, when Mn is included too much, a slab reheating temperature should be raised for adjusting a (Cu, Mn) S fine precipitate, and then primary recrystallized grains become extremely fine, so that the temperature of primary recrystallization annealing should be raised above a certain range and crystal grain non-uniformity is caused, and thus, the upper limit may be limited to 0.15%.

In addition, when Mn is added in excess, (Fe, Mn) and Mn oxides in addition to Fe₂SiO₄ are formed in a large amount on the surface of a steel sheet, so that formation of a base coating formed during secondary recrystallization annealing is prevented to deteriorate surface quality, and phase transformation non-uniformity between ferrite and austenite is caused in a primary recrystallization annealing process to make the size of primary recrystallized grains non-uniform, resulting in unstable secondary recrystallization.

### N: 0.0020 to 0.0120%

Nitrogen (N) is an element which reacts with Al and the like to refine crystal grains. When these elements are appropriately distributed, it may help to secure an appropriate primary recrystallized grain particle size by appropriately refining the structure after cold rolling as described above, but when the content is excessive, primary recrystallized grains are excessively refined, and as a result, a driving force which causes crystal grain growth during secondary recrystallization due to the fine crystal grains is increased to grow even crystal grains of undesirable orientation, which is thus not preferred. Further, when N is added too much, primary recrystallized grains are excessively refined, resulting in forming secondary recrystallization of undesirable orientation due to the fine crystal grains to deteriorate magnetic properties. Therefore, N is set to 0.0120% or less. Meanwhile, when the content of N is too low, a primary recrystallization inhibition effect is too weak, so that a stable crystal grain growth inhibition effect may not be obtained. Therefore, N may be included at 0.0020 to 0.0120% in a slab. More specifically, N may be included in a range of 0.0025 to 0.0100%. Since N is partially removed in the second recrystallization annealing process, a finally manufactured grain-oriented electrical steel sheet may include N in a range of 0.005% or less.

S: 0.010% or less

Sulfur(S) is an element which has a high solid solution temperature and severe segregation during hot rolling and is preferably not contained if possible, but a type of unavoidable impurities contained during steelmaking. In addition, since S forms (Mn, Cu) S and affects primary recrystallized grain uniformity, a content of S may be limited to 0.010% or less. More specifically, S may be included in a range of 0.001 to 0.008%.

In addition, the slab of the present disclosure may include one or more of Sn and Sb, and P.

Sum of one or more of Sn and Sb: 0.03 to 0.12%

Since tin (Sn) and antimony (Sb) are crystal grain boundary segregation elements and are elements which prevent movement of crystal grain boundaries, they are known as a crystal growth inhibitor. In addition, they increase a crystal grain fraction of Goss orientation in primary recrystallization texture to increase Goss orientation nuclei which grow to secondary recrystallization texture, so that the size a secondary recrystallization of microstructure is decreased, and thus, as the crystal grain size is decreased, Eddy current loss is decreased, so that the iron loss of a final product is decreased. When contents of Sn and Sb are too low, there is no addition effect. When the contents are too high, crystal grain growth inhibition ability is excessively increased, and thus, in order to relatively increase a crystal grain growth driving force, the crystal grain size of a primary crystal microstructure should be decreased, and thus, decarburizing annealing should be performed at a low temperature, and control to an appropriate oxidation layer is not allowed, so that a good surface may not be secured. More preferably, one or more of Sn and Sb may be included in a range of 0.04 to 0.12% alone or as the contents thereof.

### P: 0.01 to 0.05%

Phosphorus (P) is an element which shows a similar effect to Sn and Sb and may be segregated in a crystal grain boundary to play an auxiliary role to prevent movement of the crystal grain boundary and simultaneously inhibit crystal grain growth. In addition, it has an effect of improving the {110}<001> texture in terms of microstructure. When the content of P is too low, there is no addition effect, and when P is added too much, brittleness is increased to greatly deteriorate rollability, and thus, P is included in a range of 0.01 to 0.05%. More preferably, P is included in a range of 0.015 to 0.045%.

The following component elements may be added, if necessary, in the present disclosure.

### Ti: 0.002 to 0.010%

Titanium (Ti) is a strong nitride forming element and becomes TiN in a previous step of hot rolling to lower a N content and be finely precipitated to inhibit crystal grain growth. When it is added within an appropriate range, a crystal grain growth inhibition effect by formation of a TiN precipitate and an effect of reducing a deviation in a coil of crystal grain diameter by reducing AlN fine precipitates are shown.

### V: 0.002 to 0.010%

Vanadium (V) is an element which forms carbide and nitride and is finely precipitated to inhibit crystal grain growth. It is added within an appropriate range to show an effect of reducing a deviation in a coil of crystal grain diameter with a crystal grain growth inhibition effect by formation of fine precipitates.

Sum of one or more of Ti and V: 0.002 to 0.010%

In the present disclosure, when Ti and/or V is/are added, it is preferred that one or more of Ti and V are included in a range of 0.02 to 0.010% as the sum thereof, and more preferably, the sum of one or more of Ti and V is in a range of 0.003 to 0.007%.

### Cu: 0.01 to 0.20%

Cu is bonded to S to be precipitated as CuS, and is mainly mixed with MnS to form a (Mn, Cu) S form and serves to inhibit crystal grain growth. In addition, Cu causes many Goss particles of exact orientation to be formed in the structure on the hot rolled surface part, like Mo, so that a crystal grain size is decreased and Eddy current loss is decreased after second recrystallization, and thus, the iron loss of a final product is decreased, many Goss particles of exact orientation grow, and a magnetic flux density is also increased. When Cu is added into a steel sheet, when the content is less than 0.01%, the effect is insufficient, and when the content is more than 0.20%, the precipitate may coarsely grow to deteriorate a crystal grain growth inhibition effect.

### Cr: 0.02 to 0.15%

When chromium (Cr) is added within a range of 0.02 to 0.15% as an element to promote oxidation formation, formation of a dense oxidation layer on a surface part is inhibited and formation of a fine oxidation layer in a depth direction is assisted. It becomes easier to form primary recrystallized grains having excellent uniformity by adding a Cr content in an appropriate range with the addition of Sb and Sn. Decarburizing and nitriding due to increased contents of Sb and Sn are delayed by adding Cr to overcome non-uniform primary recrystallized grains, thereby forming primary recrystallized grain having excellent uniformity and showing an effect of increasing magnetism. When a Cr content is lower than the lower limit, the effect is insignificant, and when it is higher than the upper limit, an oxidation layer is excessively formed, the effect is decreased, and an increased cost is caused by adding a high-priced alloy, which is thus not preferred.

### Impurity Elements

In addition to the above elements, impurities which are unavoidably incorporated such as Zr may be included. Since Zr and the like are a strong carbonitride forming element, it is preferred not to add it if possible, and Zr is contained at 0.01% or less.

In addition to the elements described above, the remainder includes iron (Fe). In an exemplary embodiment of the present disclosure, addition of elements other than the alloy components described above is not excluded, and various elements may be included within a range which does not impair the technical idea of the present disclosure. When an additional element is further included, it is included in replacement of Fe as a remainder.

In the present disclosure, a slab having the composition components may be hot rolled to manufacture a hot rolled sheet having a thickness of 1.5 to 2.3 mm.

Herein, in the present disclosure, the contents of Al and N in the slab are characterized by being formed to satisfy the following Relations 1 and 2 depending on the thickness of the hot rolled sheet:

$$0.039 - 0.1 Ht \leq [ Al ] - 27 / 14 \times [ N ] \leq 0.047 - 0.01 Ht \qquad [ Relation 1 ]$$

$$15.5 - 5 Ht \leq [ Al ] / [ N ] \qquad [ Relation 2 ]$$

wherein [Al] and [N] denote contents (wt %) of Al and N in the slab, respectively, and Ht denotes a thickness (mm) of a final hot rolled sheet.

When [Al] −27/14×[N] of Relation 1 is smaller than the left-hand side, an amount of AlN precipitate formed by nitriding before secondary recrystallization annealing is insufficient, and [Al] −27/14×[N] is larger than the right-hand side, a suppressing force of AlN as an inhibitor is not sufficient to cause coarsening of crystal grains on the surface layer and in the center layer of a steel sheet.

As the thickness of the hot rolled sheet is smaller, a hot rolling time is longer, and a temperature difference in a length direction is increased, so that a fine AlN precipitate remaining in hot rolling is unevenly distributed to increase a deviation of magnetic properties, and thus, the contents of Al and N need to be controlled to satisfy Relation 1.

Meanwhile, when [Al]/[N] of Relation 2 is too small, the amount of AlN precipitate is increased to increase a non-uniform precipitate amount, and it is unfavorable for uniformly controlling precipitates in the post-process.

Subsequently, the hot rolled sheet manufactured above is annealed in the present disclosure.

In the present disclosure, the hot-rolled steel sheet annealing process may be performed by heating to a temperature range T1 of 1000 to 1150° C. and then cooling to a temperature range T2 of 800 to 950° C. to perform soaking annealing, and then cooling to room temperature.

Herein, in the present disclosure, a temperature difference (ΔT) between the heating temperature T1 and the soaking annealing temperature T2 is characterized by being controlled to 200° C. or more. When the temperature difference (ΔT) is less than 200° C., a precipitation driving force is insufficient, so that a problem such as an increased magnetic deviation by non-uniform precipitates may arise.

Further, in the present disclosure it is preferred to control a cooling rate during cooling from T1 to T2 to 30° C./sec or less. When the cooling rate is more than 30° C./sec, precipitate deviation for each position is caused to increase magnetic deviation.

Further, in the present disclosure, the annealed hot-rolled sheet is cold rolled to manufacture a cold rolled sheet.

In the present disclosure, the cold rolling may be performed by one strong cold rolling or a plurality of passes. During the rolling a pass aging effect may be shown by one or more warm rolling at a temperature of 200 to 300° C., and the sheet may be manufactured to a final thickness of 0.14 to 0.23 mm. The cold rolled sheet may be subjected to decarburizing, recrystallization of a transformed structure, and nitriding through nitriding gas during the first recrystallization annealing process.

Subsequently, in the present disclosure, the cold rolled steel sheet is primary recrystallization annealed.

In an exemplary embodiment of the present disclosure, in the first recrystallization annealing process, the cold rolled sheet is decarburized and nitrided, and the nitriding is performed in a soaking step during the primary recrystallization annealing process. That is, the nitriding step is performed in a separate soaking zone, respectively, or may be performed in a soaking zone which an installed screen which impedes the flow of nitriding gas to a front end and a rear end.

In the primary recrystallization process, hydrogen+nitrogen atmosphere gas with oxidation ability controlled and nitriding gas are appropriately added, so that crystal grains on the surface layer grow and are inhibited appropriately, and nitriding into the steel sheet performed well. Specifically, a nitrogen amount in the steel sheet which is increased by nitriding satisfies the following Relation 3:

$$[ Al ] - 27 / 14 \times [ N ] + ( 0.23 - Ct ) * 0.125 \leq ( 27 / 14 ) Δ N \leq 0.03 \qquad [ Relation 3 ]$$

wherein [Al] and [N] denote contents (wt %) of Al and N in the slab, respectively, and Ct denotes a thickness of a final cold rolled sheet.

In the present disclosure, when ΔN is too small, nitrogen does not penetrate into the steel sheet, only exists on the surface layer, and becomes a cause to deteriorate magnetism. On the contrary, when ΔN is too large, crystal grain growth on the surface layer part of the steel sheet is greatly inhibited to cause deterioration of magnetism.

In the present disclosure, any gas may be used as a nitriding gas without limitation as long as it is a gas which may penetrate into a steel sheet by decomposition of nitrogen at a temperature in the primary recrystallization annealing process. Specifically, the nitriding gas may include one or more of ammonia and amine. Time for performing the nitriding process may be 30 to 100 seconds.

In the present disclosure, decarburizing may also be performed in the primary recrystallization annealing step. The decarburizing may be performed in an atmosphere of oxidation ability (PH₂O/PH₂) of 0.3 to 0.7. Carbon may be included in the steel sheet at 0.005% or less, more preferably 0.003% or less by the decarburizing.

Further, in the present disclosure, a soaking temperature in the primary recrystallization annealing step may be 800 to 900° C. When the temperature is too low, primary recrystallization is not performed, or nitriding may not be performed well. When the temperature is too high, primary recrystallized grains grow too much to cause deterioration of magnetism.

Subsequently, in the present disclosure, a cold rolled sheet with the completed primary recrystallization annealing is secondary recrystallization annealed. The purpose of the second recrystallization annealing is largely to form {110}<001> texture by second recrystallization, to impart insulation by forming a glassy film by a reaction of an oxidation layer formed during decarburizing and MgO, and to remove impurities which impairs magnetic properties. As a method of the second recrystallization annealing, second recrystallized grains are developed well by protecting a nitride which is a particle growth inhibitor by maintaining the nitride with a mixed gas of nitrogen and hydrogen in a heating section before secondary recrystallization occurs, and after the secondary recrystallization is completed, the crystals are maintained in a 100% hydrogen atmosphere for a long time to remove impurities.

In the secondary recrystallization annealing process, the surface oxide layer produced in the primary recrystallization annealing process and an annealing separator are reacted to form a base coating layer. The base coating layer is distinguished from a base steel sheet in its components. For example, when MgO is used as an annealing separator, it includes forsterite.

Further, in the present disclosure, a step of forming an insulation coating layer may be further included after the secondary recrystallization annealing. Since a method for forming an insulation coating layer is well known, the specific description thereof will be omitted.

The grain-oriented electrical steel sheet of the present disclosure manufactured by the manufacturing method as described above includes, by weight: 2.5 to 4.0% of Si, 0.03 to 0.09% of C, 0.015 to 0.040% of Al, 0.04 to 0.15% of Mn, 0.01% of less (excluding 0%) of S, 0.002 to 0.012% of N, 0.010 to 0.050% of P, and 0.030 to 0.12% of the sum of one or more of Sn and Sb with a remainder of Fe and unavoidable impurities, wherein a nitrogen amount ΔN increasing in the steel sheet by nitriding satisfies the following Relation 3:

$$[ Al ] - 27 / 14 \times [ N ] + ( 0.23 - Ct ) * 0.125 \leq ( 27 / 14 ) Δ N \leq 0.03 \qquad [ Relation 3 ]$$

wherein [Al] and [N] denote contents (wt %) of Al and N in the steel sheet, respectively, and Ct denotes a steel sheet thickness.

### MODE FOR INVENTION

Hereinafter, the present disclosure will be described in detail by the preferred examples of the present disclosure. However, the following examples are only a preferred example, and the present disclosure is not limited thereto.

### Example 1

A slab having the component composition shown in the following Table 1 was dissolved under vacuum to manufacture an ingot. In Table 1, steel types A-C are inventive steels of which the alloy composition satisfied the scope of the present disclosure, steel types D-E are comparative steels of which the alloy composition did not satisfy Relation 1, and steel type F is a comparative steel of which the alloy composition did not satisfy Relation 2.

Subsequently, the ingot was heated at a temperature of 1150° C. for 210 minutes and then hot rolled to manufacture a hot rolled sheet having a thickness of 2.0 mm. Further, the hot rolled sheet was heated to a heating temperature T1 and then cooled to T2 under the hot-rolled sheet annealing conditions as shown in the following Table 2, maintained for 90 minutes, quenched in water for pickling, and strongly cold rolled once to a thickness of 0.20 mm.

Subsequently, the cold rolled sheet was maintained at a temperature of about 800 to 900° C. under a wet atmosphere of 50v % of hydrogen and 50 v % of nitrogen and an ammonia mixed gas atmosphere to be heat treated with decarburizing and nitriding annealing. At this time, the carbon content in the annealing heat treated hot rolled sheet was 30 ppm or less, and the nitriding amount was as shown in the following Table 2.

Further, MgO as an annealing separator was applied on the steel sheet which was heat treated with decarburizing annealing to finally anneal it into a coil shape. Final annealing was performed in a mixed atmosphere of 25 v % of nitrogen and 75 v % of hydrogen up to 1200° C. and when the temperature reached 1200° C., maintained in a 100% hydrogen atmosphere for 10 hours or more and furnace-cooled. Thereafter, an insulation coated composition including a metal phosphate salt and a colloidal silica mixed solution was applied on the steel sheet, and heat treated to form an insulation coating layer.

As described above, the magnetic flux density of the manufactured electrical steel sheet and the maximum and minimum values of iron loss thereof were measured and are shown in the following Table 2. For the magnetic properties, the iron loss was measured under the conditions of 1.7 Tesla and 50 Hz using a single sheet measurement method, and the size of magnetic flux density (Tesla) induced under a magnetic field of 800 A/m was measured. In addition, the magnetic properties for the entire coil were measured, and the maximum and minimum values are shown in the following Table 2.

TABLE 1

| Steel | | | | | | | | | | |
|---|---|---|---|---|---|---|---|---|---|---|
| type | C | Si | Mn | P | Sn | S | sol Al | N | Alr | Al/N |
| A | 0.05 | 3.5 | 0.11 | 0.04 | 0.07 | 0.005 | 0.0320 | 0.0057 | 0.021 | 5.6 |
| B | 0.08 | 3.4 | 0.11 | 0.04 | 0.06 | 0.006 | 0.0349 | 0.0052 | 0.025 | 6.8 |
| C | 0.06 | 3.3 | 0.11 | 0.04 | 0.07 | 0.006 | 0.0339 | 0.0036 | 0.027 | 9.3 |
| D | 0.08 | 3.4 | 0.11 | 0.05 | 0.06 | 0.005 | 0.0330 | 0.0020 | 0.029 | 16.4 |
| E | 0.06 | 3.5 | 0.10 | 0.03 | 0.07 | 0.004 | 0.0272 | 0.0052 | 0.017 | 5.2 |
| F | 0.06 | 3.5 | 0.10 | 0.04 | 0.08 | 0.005 | 0.0358 | 0.0077 | 0.021 | 4.7 |

* In Table 1, residual components are Fe and unavoidable impurities. Further, Alr denotes [Al] − 27/14 × [N] of Relation 1.

TABLE 2

| | AP | AP | | | | | | | | |
|---|---|---|---|---|---|---|---|---|---|---|
| | heating | soaking | | | | | | | | |
| | zone | zone | | DNL | | | | | | |
| | temper- | temper- | | Nitrogen | | | | | | |
| | ature | ature | T1→T2 | increase | Equation | | | | | |
| Steel | T1 | T2 | cooling | amount | 3 | B8 | B8 | W_{17/50} | W_{17/50} | |
| type | (° C.) | (° C.) | rate | (wt %) | satisfied | max | min | max | min | Remarks |
| A | 1100 | 900 | less | 0.015 | O | 1.93 | 1.91 | 0.79 | 0.75 | Inventive |
| | | | than | | | | | | | Example 1 |
| | | | 30° C./ | | | | | | | |
| | | | sec | | | | | | | |
| B | 1100 | 875 | less | 0.018 | O | 1.94 | 1.92 | 0.79 | 0.75 | Inventive |
| | | | than | | | | | | | Example 2 |
| | | | 30° C./ | | | | | | | |
| | | | sec | | | | | | | |
| C | 1100 | 850 | less | 0.018 | O | 1.93 | 1.91 | 0.78 | 0.74 | Inventive |
| | | | than | | | | | | | Example 3 |
| | | | 30° C./ | | | | | | | |
| | | | sec | | | | | | | |
| A | 1100 | 850 | less | 0.012 | X | 1.90 | 1.85 | 1.05 | 0.87 | Comparative |
| | | | than | | | | | | | Example 1 |
| | | | 30° C./ | | | | | | | |
| | | | sec | | | | | | | |
| B | 1100 | 950 | less | 0.016 | O | 1.89 | 1.86 | 1.01 | 0.88 | Comparative |
| | | | than | | | | | | | Example 2 |
| | | | 30° C./ | | | | | | | |
| | | | sec | | | | | | | |
| C | 1100 | 850 | more | 0.018 | O | 1.89 | 1.84 | 1.08 | 0.88 | Comparative |
| | | | than | | | | | | | Example 3 |
| | | | 30° C./ | | | | | | | |
| | | | sec | | | | | | | |
| D | 1100 | 875 | less | 0.018 | O | 1.90 | 1.85 | 0.96 | 0.85 | Comparative |
| | | | than | | | | | | | Example 4 |
| | | | 30° C./ | | | | | | | |
| | | | sec | | | | | | | |
| E | 1100 | 900 | less | 0.012 | O | 1.90 | 1.86 | 1.04 | 0.86 | Comparative |
| | | | than | | | | | | | Example 5 |
| | | | 30° C./ | | | | | | | |
| | | | sec | | | | | | | |
| F | 1100 | 875 | less | 0.015 | O | 1.90 | 1.88 | 0.94 | 0.86 | Comparative |
| | | | than | | | | | | | Example 6 |
| | | | 30° C./ | | | | | | | |
| | | | sec | | | | | | | |

As shown in Tables 1 and 2, Inventive Examples 1 to 3 of which the manufacturing conditions as well as the steel alloy compositions and Relations 1 and 2 satisfied the ranges of the present disclosure were all confirmed to have the small deviations of iron loss and magnetic flux density.

However, Comparative Example 1 which did not satisfy Relation 3 in the manufacturing process conditions was confirmed to lack precipitates formed in a decarburizing nitriding process (DNL) and had large deviations of iron loss and magnetic flux density.

In addition, Comparative Examples 2 and 3 of which the hot-rolled steel sheet annealing conditions are out of the ranges of the present disclosure were found to have large deviations of iron loss and magnetic flux density.

Further, it was found that Comparative Examples 4 and 5 using Comparative Steels D and E which did not satisfy Relation 1 in the steel sheet alloy compositions also had large deviations of iron loss and magnetic flux density, and also, Comparative Example 6 using steel type F which did not satisfy Relation 2 in the steel sheet alloy compositions also had large deviations of iron loss and magnetic flux density.

### Example 2

A slab having the component composition shown in the following Table 3 was dissolved under vacuum to manufacture an ingot. In the following Table 3, steel types G-I are inventive steels of which the alloy composition satisfied the scope of the present disclosure, steel types J-K is are comparative steels of which the alloy composition did not satisfy Relation 1, and steep type L is a comparative steel of which the alloy composition did not satisfy Relation 2.

Subsequently, the ingot was heated at a temperature of 1150° C. for 200 minutes and then hot rolled to manufacture a hot rolled sheet having a thickness of 1.8 mm. Further, the hot rolled sheet was heated to a heating temperature T1 and then cooled to T2 under the hot-rolled sheet annealing conditions as shown in the following Table 4, maintained for 90 minutes, quenched in water for pickling, and strongly cold rolled once to a thickness of 0.18 mm.

Subsequently, the cold rolled sheet was maintained at a temperature of about 800 to 900° C. under a wet atmosphere of 50% of hydrogen and 50 v % of nitrogen and an ammonia mixed gas atmosphere to be heat treated with decarburizing and nitriding annealing. At this time, the carbon content in the annealing heat treated hot rolled sheet was 30 ppm or less, and the nitriding amount was as shown in the following Table 4.

Further, MgO as an annealing separator was applied on the steel sheet which was heat treated with decarburizing annealing to finally anneal it into a coil shape. Final annealing was performed in a mixed atmosphere of 25 v % of nitrogen and 75 v % of hydrogen up to 1200° C. and when the temperature reached 1200° C., maintained in a 100% hydrogen atmosphere for 10 hours or more and furnace-cooled. Thereafter, an insulation coated composition including a metal phosphate salt and a colloidal silica mixed solution was applied on the steel sheet, and heat treated to form an insulation coating layer.

As described above, the magnetic flux density of the manufactured electrical steel sheet and the maximum and minimum values of iron loss thereof were measured and are shown in the following Table 4. For the magnetic properties, the iron loss was measured under the conditions of 1.7 Tesla and 50 Hz using a single sheet measurement method, and the size of magnetic flux density (Tesla) induced under a magnetic field of 800 A/m was measured. In addition, the magnetic properties for the entire coil were measured, and the maximum and minimum values are shown in the following Table 4.

TABLE 3

| Steel | | | | | | | | | | |
|---|---|---|---|---|---|---|---|---|---|---|
| type | C | Si | Mn | P | Sn | S | sol Al | N | Alr | Al/N |
| G | 0.07 | 3.5 | 0.10 | 0.04 | 0.09 | 0.006 | 0.0323 | 0.0047 | 0.023 | 6.8 |
| H | 0.07 | 3.4 | 0.09 | 0.03 | 0.06 | 0.006 | 0.0330 | 0.0043 | 0.025 | 7.7 |
| I | 0.05 | 3.3 | 0.09 | 0.03 | 0.09 | 0.005 | 0.0339 | 0.0031 | 0.028 | 10.9 |
| J | 0.08 | 3.5 | 0.11 | 0.04 | 0.06 | 0.005 | 0.0397 | 0.0031 | 0.034 | 12.6 |
| K | 0.07 | 3.4 | 0.09 | 0.04 | 0.09 | 0.006 | 0.0294 | 0.0058 | 0.018 | 5.1 |
| L | 0.07 | 3.5 | 0.10 | 0.04 | 0.09 | 0.004 | 0.0385 | 0.0070 | 0.025 | 5.5 |

* In Table 3, residual components are Fe and unavoidable impurities. Further, Alr denotes[Al] − 27/14 × [N] of Relation 1.

TABLE 4

| | AP | AP | | | | | | | | |
|---|---|---|---|---|---|---|---|---|---|---|
| | heating | soaking | | | | | | | | |
| | zone | zone | | DNL | | | | | | |
| | temper- | temper- | | nitrogen | | | | | | |
| | ature | ature | T1→T2 | increase | Equation | | | | | |
| Steel | T1 | T2 | cooling | amount | 3 | B8 | B8 | W_{17/50} | W_{17/50} | |
| type | (° C.) | (° C.) | rate | (wt %) | satisfied | max | min | max | min | Remarks |
| G | 1075 | 875 | less | 0.018 | O | 1.93 | 1.92 | 0.75 | 0.72 | Inventive |
| | | | than | | | | | | | Example 4 |
| | | | 30° C./ | | | | | | | |
| | | | sec | | | | | | | |
| H | 1075 | 875 | less | 0.018 | O | 1.93 | 1.91 | 0.74 | 0.72 | Inventive |
| | | | than | | | | | | | Example 5 |
| | | | 30° C./ | | | | | | | |
| | | | sec | | | | | | | |
| G | 1075 | 850 | less | 0.018 | O | 1.92 | 1.91 | 0.75 | 0.73 | Inventive |
| | | | than | | | | | | | Example 6 |
| | | | 30° C./ | | | | | | | |
| | | | sec | | | | | | | |
| I | 1075 | 850 | less | 0.015 | X | 1.88 | 1.85 | 1.01 | 0.90 | Comparative |
| | | | than | | | | | | | Example |
| | | | 30° C./ | | | | | | | 7 |
| | | | sec | | | | | | | |
| H | 1075 | 950 | less | 0.018 | O | 1.88 | 1.85 | 1.03 | 0.93 | Comparative |
| | | | than | | | | | | | Example |
| | | | 30° C./ | | | | | | | 8 |
| | | | sec | | | | | | | |
| I | 1075 | 850 | more | 0.018 | O | 1.89 | 1.84 | 1.06 | 0.86 | Comparative |
| | | | than | | | | | | | Example |
| | | | 30° C./ | | | | | | | 9 |
| | | | sec | | | | | | | |
| J | 1075 | 875 | less | 0.02 | O | 1.89 | 1.86 | 0.98 | 0.87 | Comparative |
| | | | than | | | | | | | Example |
| | | | 30° C./ | | | | | | | 10 |
| | | | sec | | | | | | | |
| K | 1075 | 875 | less | 0.018 | O | 1.89 | 1.86 | 1.00 | 0.88 | Comparative |
| | | | than | | | | | | | Example |
| | | | 30° C./ | | | | | | | 11 |
| | | | sec | | | | | | | |
| L | 1075 | 875 | less | 0.018 | O | 1.89 | 1.85 | 1.07 | 0.88 | Comparative |
| | | | than | | | | | | | Example |
| | | | 30° C./ | | | | | | | 12 |
| | | | sec | | | | | | | |

As shown in Tables 3 and 4, Inventive Examples 1 to 3 of which the manufacturing conditions as well as the steel alloy compositions and Relations 1 and 2 satisfied the ranges of the present disclosure were all confirmed to have the small deviations of iron loss and magnetic flux density.

However, Comparative Examples 7 to 12 of which the steel sheet composition components (Relation) or the manufacturing process conditions are out of the ranges of the present disclosure were all confirmed to have large deviations of iron loss and magnetic flux density. In particular, Comparative Example 7 which did not satisfy Relation 3 in the manufacturing process conditions lacked DNL formation precipitates and showed large deviations of iron loss and magnetic flux density.

As seen from the descriptions of the examples, Inventive Examples 1 to 6 of which the Al and N content ranges in the steel sheet depending on the hot rolled sheet thickness were appropriately secured within the suggested ranges, the AP annealing conditions were optimized, and the nitriding conditions depending on the cold rolled sheet thickness during primary recrystallization annealing were optimized were all confirmed to have small deviations of iron loss and magnetic flux density.

However, Comparative Examples 1 to 12 of which the Al and N content ranges in the steel sheet depending on the hot rolled sheet thickness were out of the suggested ranges of the present disclosure, the AP annealing conditions were out of the suggested range of the present disclosure, or the nitriding conditions depending on the cold rolled sheet thickness during the primary recrystallization annealing were out of the range of the present disclosure were confirmed to have poor iron loss and magnetic flux density and have large deviations thereof.

While example embodiments have been shown and described above, it will be apparent to those skilled in the art that modifications and variations could be made without departing from the scope of the present disclosure as defined by the appended claims.

1. A manufacturing method for a thin grain-oriented electrical steel sheet, the method comprising:
hot rolling a slab including, by weight: 2.5 to 4.0% of Si, 0.03 to 0.09% of C, 0.0150 to 0.0400% of Al, 0.04 to 0.15% of Mn, 0.010% of less (excluding 0%) of S, 0.0020 to 0.0120% of N, 0.010 to 0.050% of P, and 0.03 to 0.12% of a sum of one or more of Sn and Sb with a remainder of Fe and unavoidable impurities to manufacture a hot rolled sheet; annealing the hot rolled sheet; cold rolling the annealed hot-rolled sheet to manufacture a cold rolled sheet; performing primary recrystallization annealing by decarburizing and nitriding the cold rolled sheet; and performing secondary recrystallization annealing of the cold rolled sheet after completing the primary recrystallization annealing,
wherein contents of Al and N in the slab satisfy the following Relations 1 and 2,
when a temperature difference between a heating temperature T1 and a soaking annealing temperature T2 in the hot-rolled sheet annealing is ΔT, ΔT≥200° C. is satisfied, and when cooling from T1 to T2, a cooling rate is controlled to 30° C./sec or less, and
a nitrogen amount ΔN increasing in the cold rolled sheet by the nitriding in the primary recrystallization annealing satisfies the following Relation 3:
$$0.039 - 0.1 Ht \leq [ Al ] - 27 / 14 \times [ N ] \leq 0.047 - 0.01 Ht \qquad [ Relation 1 ]$$
$$15.5 - 5 Ht \leq [ Al ] / [ N ] \qquad [ Relation 2 ]$$
wherein [Al] and [N] denote contents (wt %) of Al and N in the slab, respectively, and Ht denotes a thickness (mm) of a final hot rolled sheet,
$$[ Al ] - 27 / 14 \times [ N ] + ( 0.23 - Ct ) * 0.125 \leq ( 27 / 14 ) Δ N \leq 0.03 \qquad [ Relation 3 ]$$
wherein [Al] and [N] denote contents (wt %) of Al and N in the slab, respectively, and Ct denotes a thickness of a final cold rolled sheet.

2. The manufacturing method for a thin grain-oriented electrical steel sheet of claim 1, wherein the slab further includes 0.02 to 0.15% of Cr.

3. The manufacturing method for a thin grain-oriented electrical steel sheet of claim 1, wherein the slab further includes 0.01 to 0.2% of Cu or 0.01 to 0.05% of Bi.

4. The manufacturing method for a thin grain-oriented electrical steel sheet of claim 1, wherein the slab includes a sum of one or more of 0.002 to 0.010% of Ti and 0.002 to 0.010% of V in a range of 0.003 to 0.007%.

5. The manufacturing method for a thin grain-oriented electrical steel sheet of claim 1, wherein the primary recrystallization annealing process is performed at a temperature of 800 to 900° C. for 60 to 180 seconds.

6. A thin grain-oriented electrical steel sheet comprising, by weight: 2.5 to 4.0% of Si, 0.03 to 0.09% of C, 0.0150 to 0.0400% of Al, 0.04 to 0.15% of Mn, 0.010% of less (excluding 0%) of S, 0.0020 to 0.0120% of N, 0.010 to 0.050% of P, and 0.03 to 0.12% of a sum of one or more of Sn and Sb with a remainder of Fe and unavoidable impurities, wherein a nitrogen amount ΔN increasing in the steel sheet by nitriding satisfies the following Relation 3:
$$[ Al ] - 27 / 14 \times [ N ] + ( 0.23 - Ct ) * 0.125 \leq ( 27 / 14 ) Δ N \leq 0.03 \qquad [ Relation 3 ]$$
wherein [Al] and [N] denote contents (wt %) of Al and N in the steel sheet, respectively, and Ct denotes a steel sheet thickness.

7. The thin grain-oriented electrical steel sheet of claim 6, wherein the steel sheet further includes 0.02 to 0.15% of Cr.

8. The thin grain-oriented electrical steel sheet of claim 6, wherein the steel sheet further includes 0.01 to 0.2% of Cu or 0.01 to 0.05% of Bi.

9. The thin grain-oriented electrical steel sheet of claim 6, wherein the steel sheet includes a sum of one or more of 0.002 to 0.010% of Ti and 0.002 to 0.010% of V in a range of 0.003 to 0.007%.
